(19) United States
(12) Patent Application Publication
(10) Pub. No.: US 2023/0365046 A1
(43) Pub. Date: Nov. 16, 2023

(54) FOLDABLE TRAILING WITH OFFSET AXLE LOWERABLE DECK

(71) Applicant: Alfred Lex Spaeth, Lincoln, CA (US)

(72) Inventor: Alfred Lex Spaeth, Lincoln, CA (US)

(21) Appl. No.: 18/302,561

(22) Filed: Apr. 18, 2023

Related U.S. Application Data
(60) Provisional application No. 63/332,250, filed on Apr. 18, 2022.

(51) Int. Cl. B60P 1/04; B60P 3/07; B62D 63/06

(52) U.S. Cl. CPC B60P 1/04; B60P 3/07; B62D 63/061

(57) ABSTRACT

A folding trailer having a deck which can be raised and lowered to facilitate mounting and dismounting a vehicle or other item from the deck. The rear axle of the trailer is configured with a pivoting offset axle which enables raising and lowering of the deck relative to the rear support wheels.

### CLAIM OF PRIORITY

This application claims the benefit of priority to prior-filed and co-pending U.S. Provisional Patent Application No. 63/332,250 filed Apr. 18, 2022 by Alfred Lex Spaeth, the complete contents of which are hereby incorporated herein by reference.

### BACKGROUND

### Technical Field

The present application relates to the field of transportation vehicles and more specifically to the field of foldable trailers with offset axles enabling lowerable decks.

### Background

Trailers are commonly needed for transportation of other vehicles and/or transportation of items. While some people would like to own a trailer for convenience, many do not have the available space to store them, as their storage requires a great deal of space. Thus, many do not purchase trailers due to the storage space required. Additionally, trailers that have a rear axle, versus a longitudinal-centrally located axle, are incapable of angling the deck to facilitate on and offboarding of items from the trailer's deck. What is needed is a foldable trailer with a rear, offset axle such that a deck is capable of being lowered/angled at the rear end.

### SUMMARY

One general aspect includes a deck having a first portion and a second portion. The deck can further comprise a hinge coupling said first portion and said second portion, where said first portion and said second portion are adapted and configured be transitionable between a flat configuration and a folded configuration. The deck can also comprise a first portion of said deck being supported by a rear offset axle, said rear offset axle being coupled with a substantially central axle of at least one wheel supporting said deck via an offset element. In some embodiments, the deck can further comprise a lever arm coupled with said rear offset axle, where when said lever arm is in a first position, said deck is in a raised position relative to a surface on which said at least one wheel rests. In some embodiments, the deck also comprises where when said lever arm is in a second position, said deck is in a lowered position relative to a surface on which said at least one wheel rests.

One general aspect includes an offset axle assembly which can comprise a central rod, an axle attachment component coupled with a first end of said central rod, an offset axle surrounding said central rod such that said central rod can rotate about a longitudinal axis within said offset axle and a wheel axle configured to indirectly couple with said central rod, where said longitudinal axis of said central rod is not colinear with a longitudinal axis of said wheel axle.

### BRIEF DESCRIPTION OF THE DRAWINGS

Further details of the present device are explained with the help of the attached drawings in which:

FIG. 1 depicts an overview of a folding trailer with a deck adapted and configured to be lowered and/or angled.

FIG. 2 depicts a rear view of the trailer depicted in FIG. 1

FIG. 3 depicts a front view of the trailer depicted in FIG. 1 in a folded configuration.

FIG. 4 depicts a rear view of the frame of the trailer depicted in FIG. 1, in a folded configuration.

FIG. 5 depicts a side view of the trailer depicted in FIG. 1, in a folded configuration.

FIG. 6 depicts the hinge point of the trailer depicted in FIG. 1, in a folded configuration.

FIG. 7 depicts the hinge point of the trailer depicted in FIG. 1, in a flat configuration.

FIG. 8 depicts a top view of the hinge point of the trailer depicted in FIG. 1 in a flat configuration.

FIG. 9 depicts an underside view of the trailer depicted in FIG. 1, in a partially-folded configuration.

FIG. 10 depicts a rear view of the trailer depicted in FIG. 1 with the deck in a lowered configuration.

FIG. 11 depicts a close-up view of a rear wheel and axle configuration of the trailer depicted in FIG. 1 with the deck in a lowered configuration.

FIG. 12 depicts a close-up view of a rear wheel and axle configuration of the trailer depicted in FIG. 1 with the deck in a raised configuration.

FIG. 13 depicts a side view of the trailer depicted in FIG. 1 with the deck in a lowered configuration.

FIG. 14 depicts a top-down view of the trailer depicted in FIG. 1 with the deck in a raised configuration.

FIG. 15 depicts a rear view of an alternate embodiment of the folding trailer depicted in FIG. 1.

FIG. 16 depicts a side elevation view of the alternate embodiment of the folding trailer depicted in FIG. 15 in a folded configuration.

FIG. 17 depicts a side elevation view of the alternate embodiment of the folding trailer depicted in FIG. 15 in a partially folded configuration.

FIG. 18 depicts an exploded view of the offset axle assembly.

FIG. 19 depicts a cross-section view of the offset axle assembly depicted in FIG. 18.

FIG. 20 depicts a partially assembled view of the offset axle assembly depicted in FIGS. 18 and 19.

FIG. 21 depicts an assembled view of the offset axle assembly depicted in FIGS. 18-20, in use in a raised configuration.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

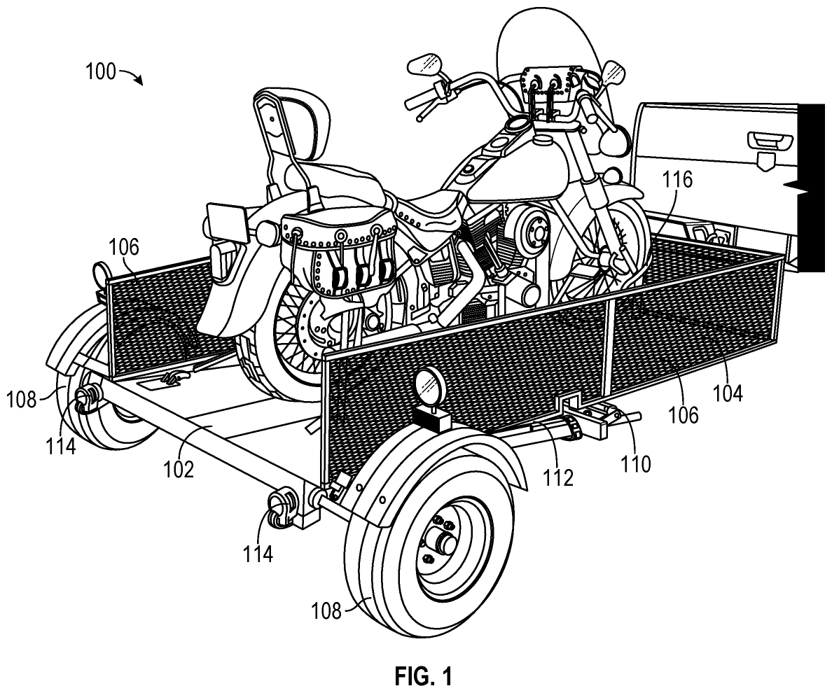

FIG. 1 depicts an overview of a folding trailer 100 with a deck 102 104 adapted and configured to be lowered and/or angled. In the embodiment depicted in FIG. 1, the trailer 100 comprises a first deck 102 and a second deck 104, selectively removable/positionable perimeter panels 106, primary support wheels 108 and a hinge 110 coupling the first deck 102 and the second deck adapted and configured to facilitate folding of the trailer 100.

In the embodiment depicted in FIG. 1, the trailer 100 also comprises a lever arm 112 adapted and configured to facilitate raising/lowering of the deck 102 104 relative to the ground. The embodiment depicted in FIG. 1 further comprises caster wheels 114, in which the trailer 100 can transition to and be supported on when in a folded configuration. Further, in some embodiments, the trailer can further comprise a wheel anchor 116, and/or known convenient and/or desired component to aid in stabilization of an item supported on the deck 102 104 of the trailer 100.

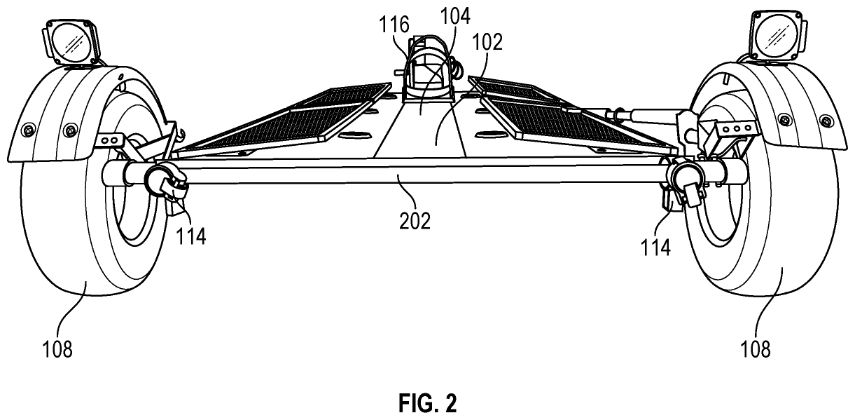

FIG. 2 depicts a rear view of the trailer 100 depicted in FIG. 1 comprising a rear offset axle 202 which supports the rear portion of the deck 102 and can be selectively lowered to ground level and/or raised such that it is at substantially the same elevation above the ground as axles of the primary support wheels 108. In the embodiment depicted in FIG. 2, the perimeter panels 106 are depicted in a folded position.

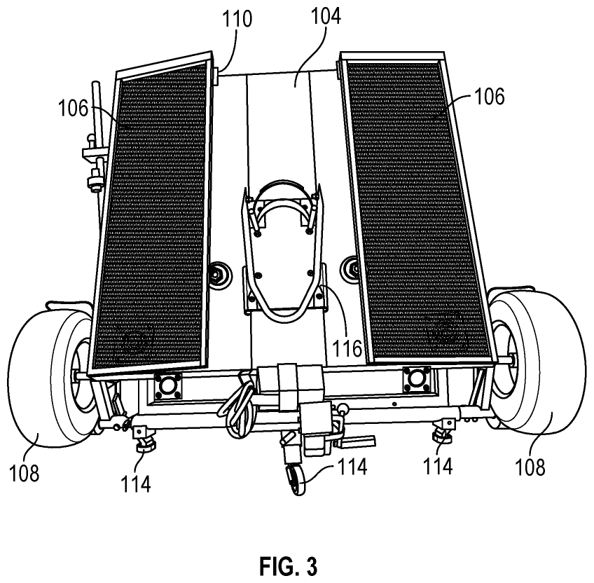

FIG. 3 depicts a front view of the trailer 100 depicted in FIG. 1 in a folded configuration. In the embodiment depicted in FIG. 3, the trailer 100 is depicted such that the deck 102 104 is folded along the hinge 110 line with the two distal ends of the deck 102 104 coming together. In the embodiment depicted in FIG. 3, when the trailer 100 is folded, the entire trailer 100 transitions to being supported by the caster wheels 114 and the primary support wheels 108 are raised off the ground, such that the folded trailer 100 can be easily maneuvered, rotated and positioned.

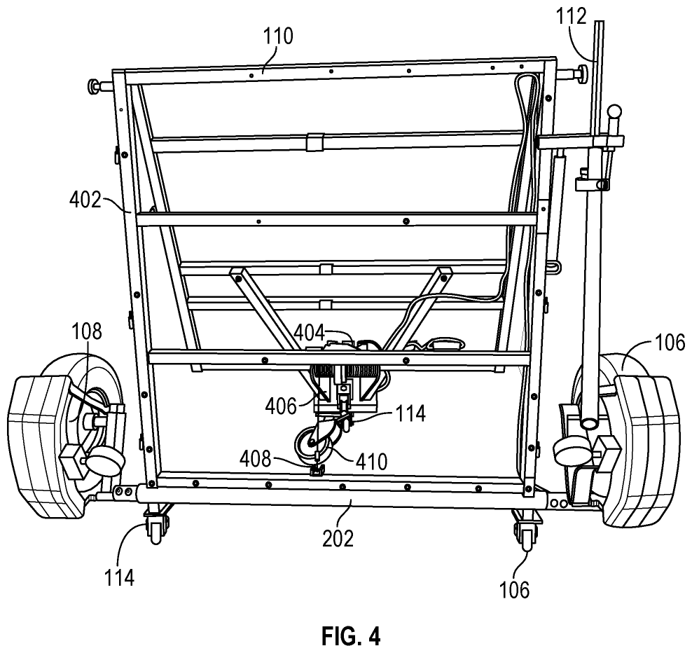

FIG. 4 depicts a rear view of the frame 402 of the trailer 100 depicted in FIG. 1, in a folded configuration with the deck 102 104 removed. In the embodiment depicted in FIG. 4, a winch 404 is coupled with the frame wherein the winch is coupled with a cable 406, the cable 406 being attached to the rear offset axle 202 at an attachment point 408. In operation, when the winch is activated, the cable 406 is pulled in tension and pulls the rear offset axle 202 toward the winch, thus folding the trailer 100 at the hinge 110 line and pulling the trailer of its primary front wheel 410 and primary support wheels 108 and onto the caster wheels 114. Conversely, when the tension in the cable 406 is released by reversal of the winch direction, the trailer 100 can unfold along the hinge 110 line creating a flat deck 102 104 wherein the trailer is supported on the primary support wheels 108 and the front wheel 410.

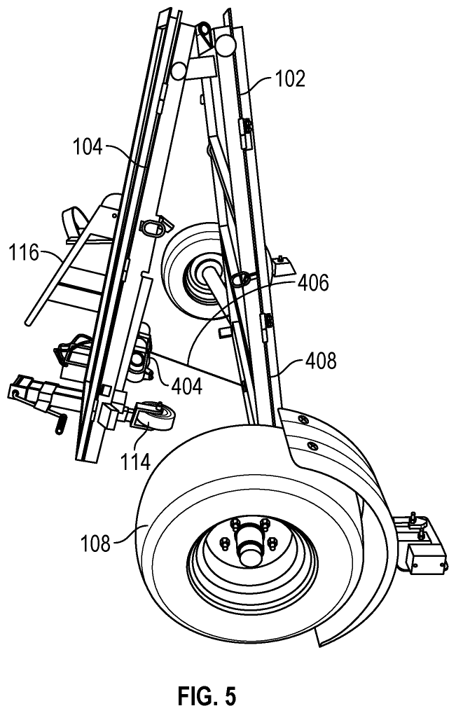

FIG. 5 depicts a side view of the trailer 100 depicted in FIG. 1, in a folded configuration. As described in relation to FIG. 4. In operation, when the winch is activated, the cable 406 is pulled in tension and pulls the rear offset axle 202 toward the winch, thus folding the trailer 100 at the hinge 110 line and pulling the trailer of its primary front wheel 410 and primary support wheels 108 and onto the caster wheels 114. Conversely, when the tension in the cable 406 is released by reversal of the winch direction, the trailer 100 can unfold along the hinge 110 line creating a flat deck 102 104 wherein the trailer is supported on the primary support wheels 108 and the front wheel 410.

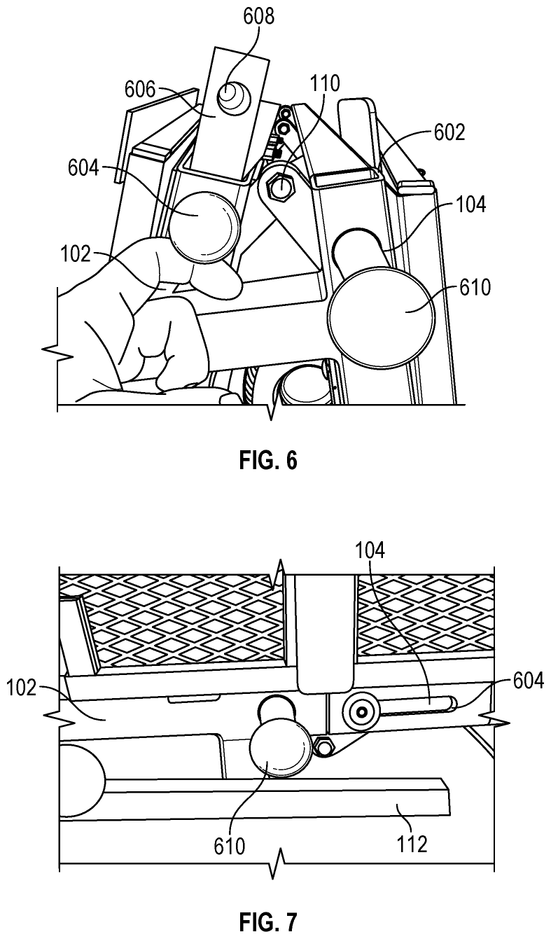

FIG. 6 depicts the hinge point 110 of the trailer 100 depicted in FIG. 1, in a folded configuration. As depicted in FIG. 6, at the hinge 110 line the two portions of the deck 102 104 can be coupled via a retractable pin 606 that engages with an aperture 602 in the frame 402 associated with the other portion of the deck 102 104. The pin 606 can be slidably retracted or extended via a slot 604 such that it is contained with the frame 402 and/or extends from the frame and can engage with the aperture 602. In some embodiments, the pin 606 can comprise an aperture 608 adapted and configured such that a complimentary pin 610 can selectively engage the aperture 608 in the pin 606 and restrain and contain the pin 606 within the aperture 602 and create aid in structural continuity of the deck 102 104 across the hinge 110 line of the frame 402.

FIG. 7 depicts the hinge point of the trailer 100 depicted in FIG. 1, in a flat configuration. In the embodiment depicted in FIG. 7, the deck 102 104 and frame 402 are in a substantially flat configuration and the pin 606 is engaged in the aperture 602 and restrained by the complimentary pin 610 across the hinge 110 line.

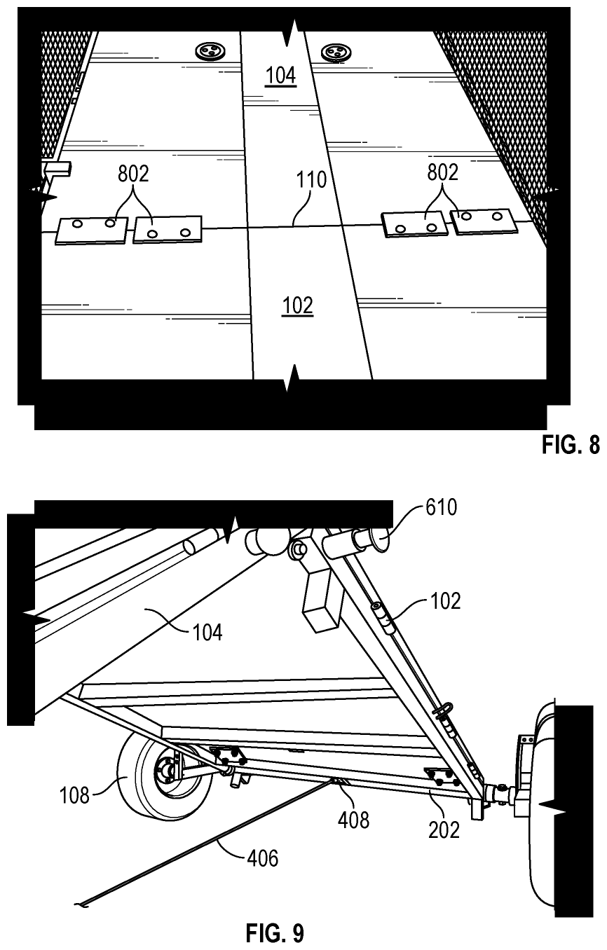

FIG. 8 depicts a top view of the hinge point 110 of the trailer 100 depicted in FIG. 1 in a flat configuration. In the embodiment depicted in FIG. 8, the trailer 100 further comprises continuity elements 802 coupled with the deck 102 104 and the frame 402. In the flat configuration depicted in FIG. 8, the continuity elements 802 are attached to one portion of the top surface of the deck 102 104 and frame 402 in extend across the hinge 110 line to aid in structural continuity across the hinge 110 line.

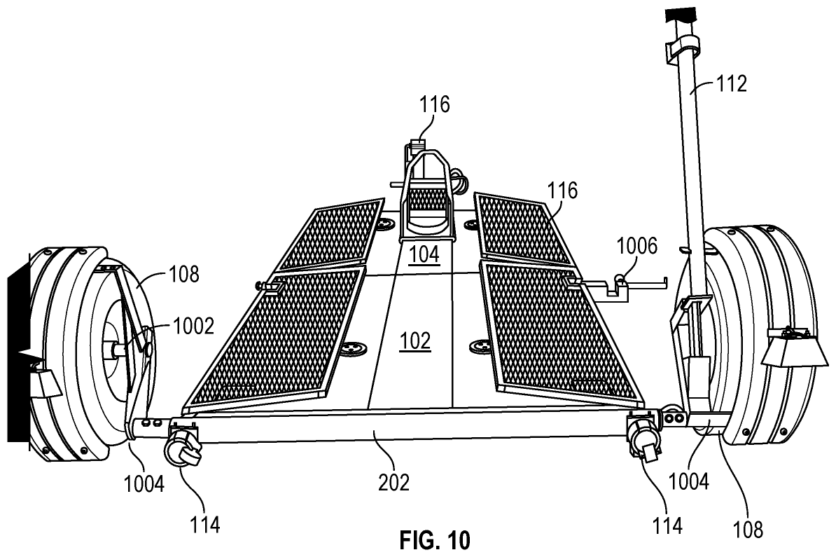

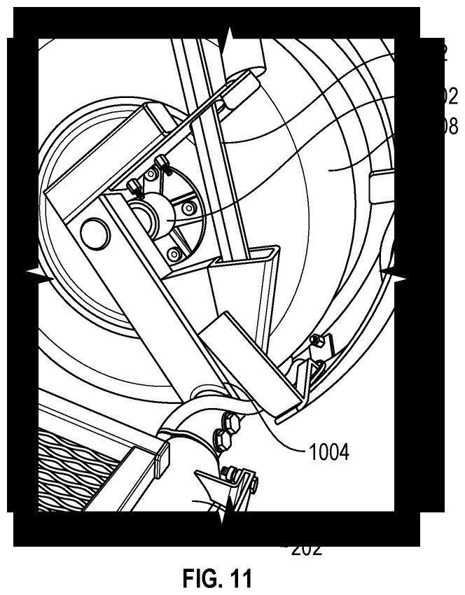

FIG. 9 depicts an underside view of the trailer 100 depicted in FIG. 1, in a partially-folded configuration. In the embodiment depicted in FIG. 9, the cable 406 is in tension thus drawing the primary rear wheels 108 toward the winch (not shown) and pulling the trailer onto the caster wheels 114.

FIG. 10 depicts a rear view of the trailer 100 depicted in FIG. 1 with the deck 102 104 in a lowered configuration. In the embodiment depicted in FIG. 10, the trailer 100 comprises wheel axles 1002 that extend from the centers of the wheels 108 and engage with a first end of an offset element 1004. The opposing end of the offset element 1004 being coupled with the rear offset axle 202 and the lever arm 112. In operation, when the lever arm 112 is released from the engagement device 1006, and rotated about the wheel axles 1002, the rear offset axle 202 is lowered to at or near ground level facilitating loading of the trailer 100. Additionally, when the lever arm 112 is engaged with the engagement device 1006, the rear offset axle 202 is raised to be at or near the same level as the wheel axles 1002 and the deck 102 104 raised to a flat or substantially flat configuration.

FIG. 11 depicts a close-up view of a rear wheel and axle configuration of the trailer 100 depicted in FIG. 1 with the deck 102 104 in a lowered configuration. As described in relation to FIG. 10 in operation, when the lever arm 112 is released from the engagement device 1006, and rotated about the wheel axles 1002, the rear offset axle 202 is lowered to at or near ground level facilitating loading of the trailer 100. Additionally, when the lever arm 112 is engaged with the engagement device 1006, the rear offset axle 202 is raised to be at or near the same level as the wheel axles 1002 and the deck 102 104 raised to a flat or substantially flat configuration.

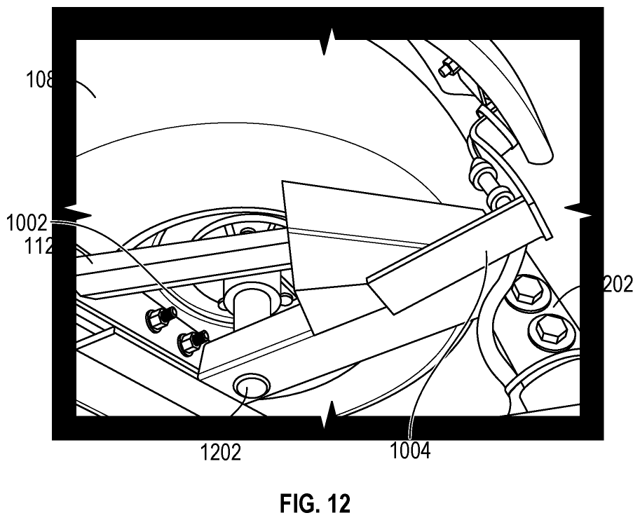

FIG. 12 depicts a close-up view of a rear wheel and axle configuration of the trailer 100 depicted in FIG. 1 with the deck 102 104 in a raised configuration. As described in relation to FIGS. 10 and 11, in operation, when the lever arm 112 is released from the engagement device 1006, and rotated about the wheel axles 1002, the rear offset axle 202 is lowered to at or near ground level facilitating loading of the trailer 100. Additionally, when the lever arm 112 is engaged with the engagement device 1006, the rear offset axle 202 is raised to be at or near the same level as the wheel axles 1002 and the deck 102 104 raised to a flat or substantially flat configuration.

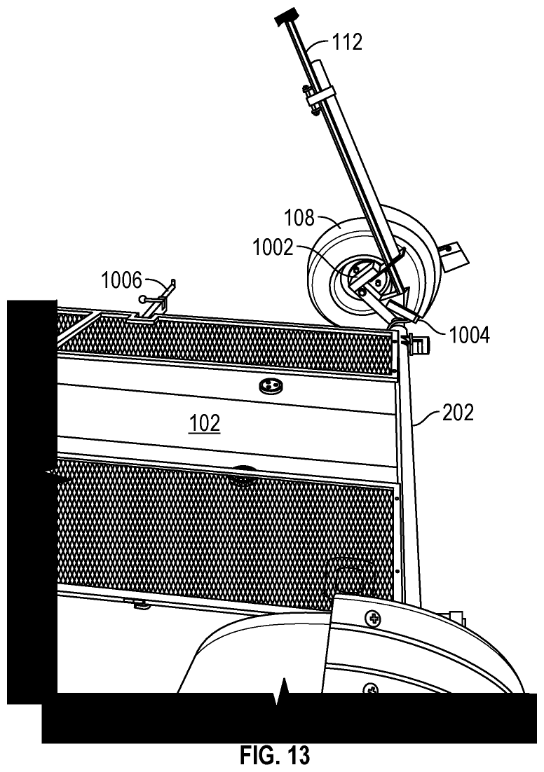

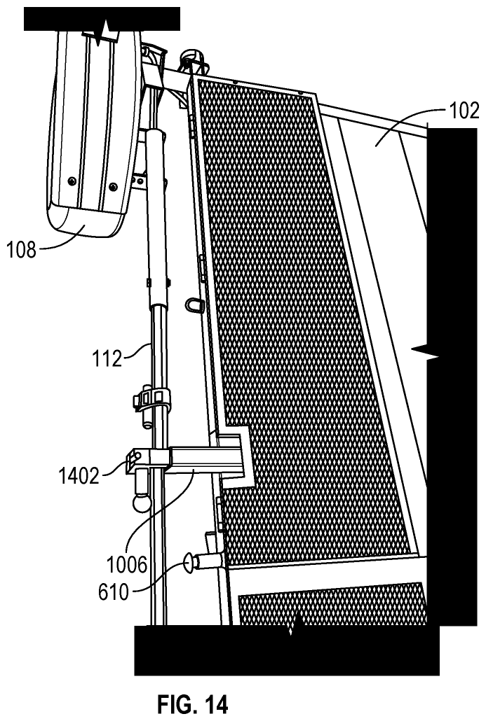

FIG. 13 depicts a side view of the trailer 100 depicted in FIG. 1 with the deck 102 104 in a lowered configuration. As described in relation to FIGS. 10-12, in operation, when the lever arm 112 is released from the engagement device 1006, and rotated about the wheel axles 1002, the rear offset axle 202 is lowered to at or near ground level facilitating loading of the trailer 100. Additionally, when the lever arm 112 is engaged with the engagement device 1006, the rear offset axle 202 is raised to be at or near the same level as the wheel axles 1002 and the deck 102 104 raised to a flat or substantially flat configuration.

FIG. 14 depicts a top-down view of the trailer 100 depicted in FIG. 1 with the deck 102 104 in a raised configuration. In the embodiment depicted in FIG. 14, the lever arm 112 is depicted as engaged with the engagement device via a cross pin 1402. However, in alternate embodiments the cross pin 1402 can be substituted with any known convenient and/or desired mechanism that can selectively engage and retain the lever arm 112 to support the deck 102 104.

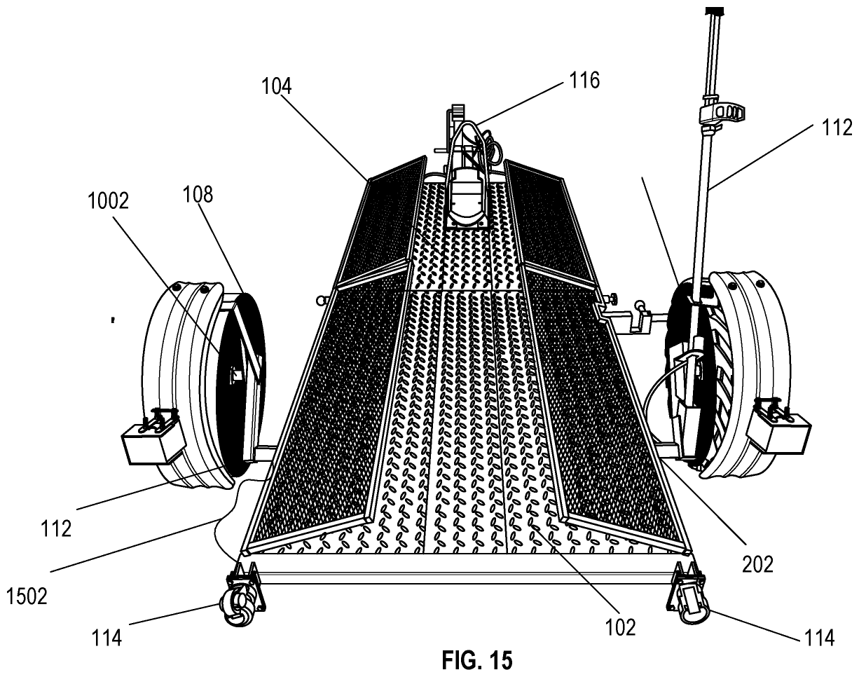

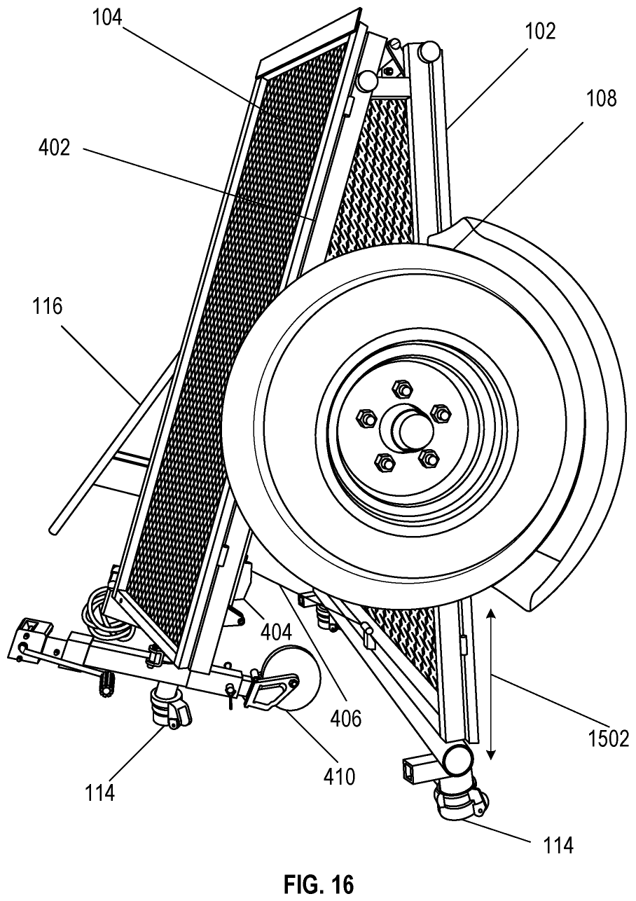

FIG. 15 depicts a rear view of an alternate embodiment of the folding trailer 100 depicted in FIG. 1. In the embodiment depicted in FIG. 15, the rear offset axle 202 is positioned centrally along the length of the deck 102. That is, the rear offset axle 202 is offset from the rear edge of the deck 102 by an offset distance 1502. In some embodiments, the offset distance 1502 can be equal or substantially equal to ⅓ of the overall length of the deck 102. However, in alternate embodiments the offset distance 1502 can be any known, convenient and/or desired distance and/or the offset axle 202 can be positioned in any known, convenient and/or desired location along the length of the deck 102.

FIG. 16 depicts a side elevation view of the alternate embodiment of the folding trailer 100 depicted in FIG. 15 in a folded configuration. In the embodiment depicted in FIG. 16, the rear, offset axle 202 is positioned at a distance 1502 approximately at the midpoint of deck 102. Additionally, in the embodiment depicted in FIG. 16, the trailer 102 is depicted as being supported on caster wheels 114.

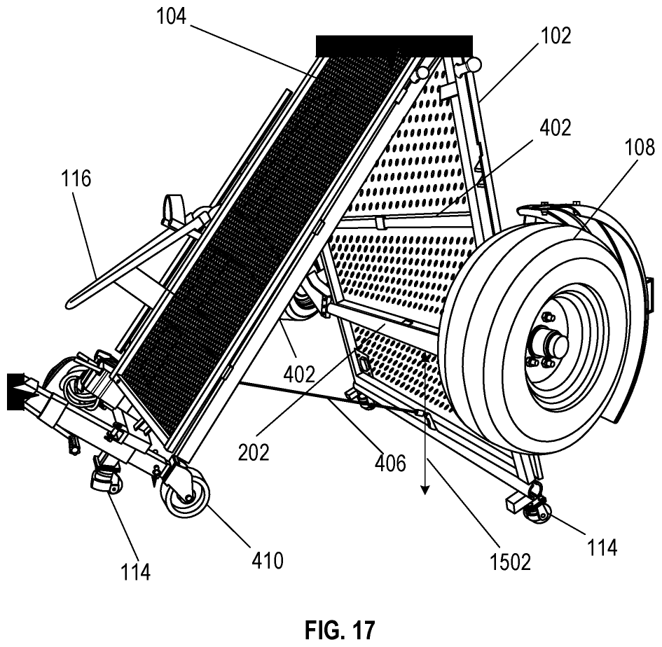

FIG. 17 depicts a side elevation view of the alternate embodiment of the folding trailer 100 depicted in FIG. 15 in a partially folded configuration. In the embodiment depicted in FIG. 17, trailer 100 deck 102 is supported on caster wheels 114 and the trailer deck 114 is support on the front wheel 410 (transitioned to or from the front caster wheel 114). Additionally, the rear offset axle 202 is depicted as being coupled the frame 402 of the rear deck 102. In the embodiment depicted in FIG. 17, the rear axle 202 is coupled with a cross bar of the from 402. However, in alternate embodiments, the rear axle 202 can be coupled with any known, convenient and/or desired portion of the rear deck 102 and/or frame 402 in any known, convenient and/or desired location. In the embodiment depicted in FIG. 17, the rear axle 202 can be coupled with the rear deck 102 in any known, convenient and/or desired coupling mechanism, such as welding, one or more fasteners and/or adhesives. In further alternate embodiments, the rear axle 202 can be fabricated as integral with the frame 402 and/or deck 102.

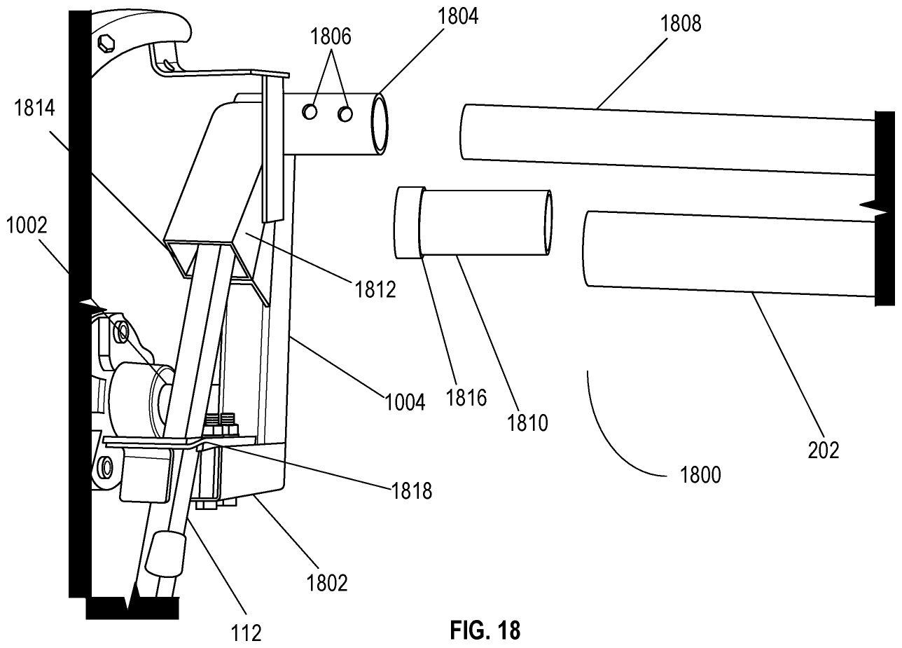

FIG. 18 depicts an exploded view of the offset axle assembly 1800. In the embodiment depicted in FIG. 18, the offset axle assembly 1800 can be comprised of an axle attachment component 1804 which can have one or more apertures 1806 to enable attachment of a central rod 1808 to the axle attachment component 1804. Additionally, the offset axle assembly 1800 can further comprise an attachment sleeve 1810 adapted and configured to surround the central rod and/or the axle attachment component 1804 and adapted and configured to fit within the rear axle 202 and enable rotation of the axle 202 relative to the central rod 1808. In some embodiments, the central rod (or central axle) 1808 can be solid rod and/or can be a hollow tube. Additionally, in some embodiments the attachment sleeve 1810 can comprise a stop element 1816 adapted and configured to selectively engage the end of the axle 202 and restrict longitudinal movement of the axle 202, but enable rotational movement of the axle 202, axle attachment component 1804 and/or the central rod relative to each other when the offset axle assembly 1800 is assembled.

Additionally, the offset axle assembly 1800 comprises a first offset component 1004 along a first axis and a second offset component 1802 in as alternate direction relative to the first offset component 1004. In some embodiments, first offset component 1004 and the second offset component 1802 can be orthogonal. However, in alternate embodiments, the first offset component 1004 and the second offset component 1802 can have any known convenient and/or desired geometric configuration and/or orientation.

Further, in the embodiment depicted in FIG. 18, the offset axle assembly 1800 can further comprise a lever arm 112 attachment component 1814 that is coupled with an offset at an angle 1812 relative to the first offset component 1004. Additionally, the lever arm 112 can be coupled with the attachment component 1814 and oriented and/or restrained in movement by a retention component 1818. And either the first offset component 1004 and/or the second offset component 1802 can be coupled with wheel axle 1002

In operation, the wheel 108 can rotate relative to or via the wheel axle 1002 absent inducing significant rotation or rotational force in the offset axle assembly 1800. The offset axle assembly 1800 can be rotated via the lever arm between a first position in which the deck 102 is in an elevated position and a second position in which the deck 102 is in a lowered position, thereby angling the deck 102 and/or decks 102/104 to facilitate mounting or dismounting of a vehicle or other item from the trailer 100. That is the longitudinal axis of the central rod 1808 is not colinear with the longitudinal axis of said wheel axle 1002.

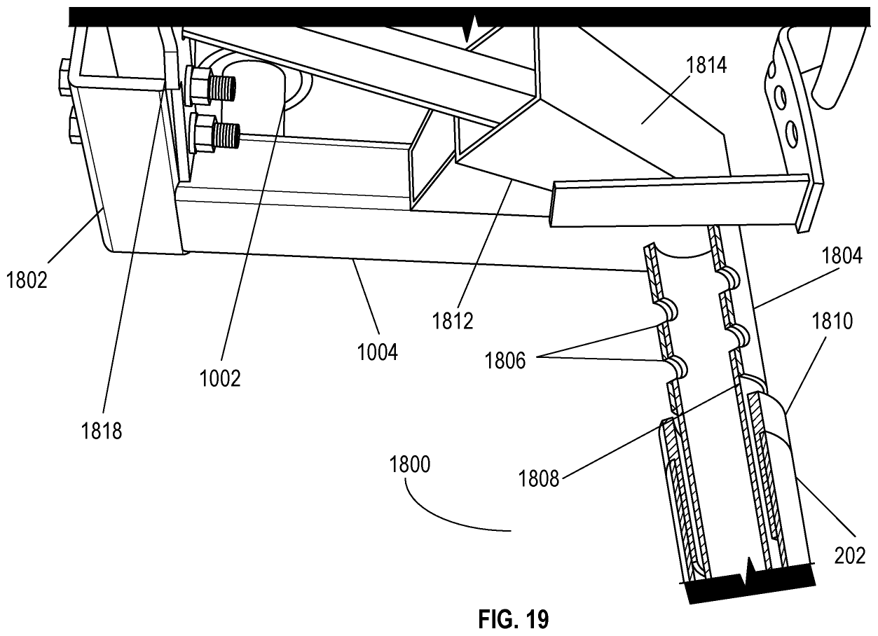

FIG. 19 depicts a cross-section view of the offset axle assembly depicted in FIG. 18. As depicted in FIG. 19, the central rod 1808 is coupled within the axle attachment component 1804 and within the attachment sleeve 1810 and the offset axle 202 surrounds the attachment sleeve 1810 to support the deck 102. In operation, the attachment sleeve 1810 enables rotation of the offset axle 202 relative to the central rod 1808 and the axle attachment component 1804. The apertures 1806 in the axle attachment component 1804 and the central rod 1808 are adapted and configured to be aligned and accept fasteners (such as bolts, clasps, pins and/or any other known, convenient and/or desired fastener) to selectively couple the central rod 1808 and the axle attachment component 1804. In some embodiments, the attachment sleeve 1810 may be absent.

Again, in operation, wheel 108 can rotate relative to or via the wheel axle 1002 absent inducing significant rotation or rotational force in the offset axle assembly 1800. The offset axle assembly 1800 can be rotated via the lever arm between a first position in which the deck 102 is in an elevated position and a second position in which the deck 102 is in a lowered position, thereby angling the deck 102 and/or decks 102/104 to facilitate mounting or dismounting of a vehicle or other item from the trailer 100.

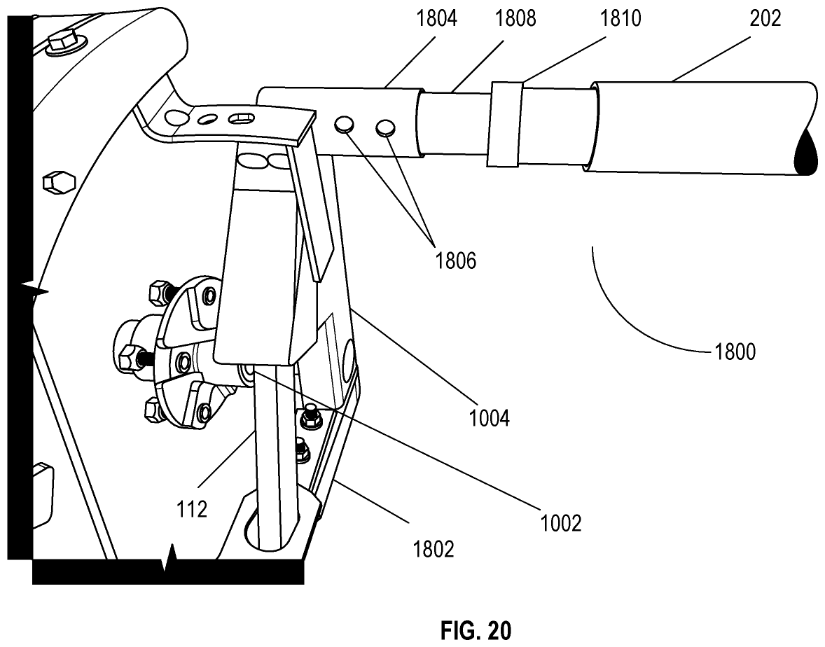

FIG. 20 depicts a partially assembled view of the offset axle assembly depicted in FIGS. 18 and 19. As depicted in FIG. 20, the central rod 1808 is coupled within the axle attachment component 1804 and within the attachment sleeve 1810 and the offset axle 202 surrounds the attachment sleeve 1810 to support the deck 102. In operation, the attachment sleeve 1810 enables rotation of the offset axle 202 relative to the central rod 1808 and the axle attachment component 1804. The apertures 1806 in the axle attachment component 1804 and the central rod 1808 are adapted and configured to be aligned and accept fasteners (such as bolts, clasps, pins and/or any other known, convenient and/or desired fastener) to selectively couple the central rod 1808 and the axle attachment component 1804.

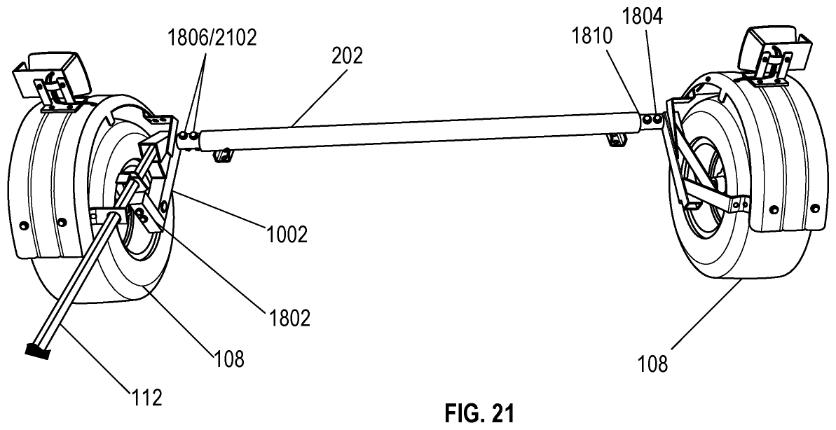

FIG. 21 depicts an assembled view of the offset axle assembly depicted in FIGS. 18-20, in use in a raised configuration. As depicted in FIG. 21, the central rod 1808 is coupled within the axle attachment component 1804 and within the attachment sleeve 1810 and the offset axle 202 surrounds the attachment sleeve 1810 to support the deck 102. In operation, the attachment sleeve 1810 enables rotation of the offset axle 202 relative to the central rod 1808 and the axle attachment component 1804. The apertures 1806 in the axle attachment component 1804 and the central rod 1808 are adapted and configured to be aligned and accept fasteners 2102 (such as bolts, clasps, pins and/or any other known, convenient and/or desired fastener) to selectively couple the central rod 1808 and the axle attachment component 1804.

Again, in operation, wheel 108 can rotate relative to or via the wheel axle 1002 absent inducing significant rotation or rotational force in the offset axle assembly 1800. The offset axle assembly 1800 can be rotated via the lever arm between a first position in which the deck 102 is in an elevated position and a second position in which the deck 102 is in a lowered position, thereby angling the deck 102 and/or decks 102/104 to facilitate mounting or dismounting of a vehicle or other item from the trailer 100.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A trailer comprising;
a deck having a first portion and a second portion;
a hinge coupling said first portion and said second portion;
wherein said first portion and said second portion are adapted and configured be transitionable between a flat configuration and a folded configuration;
said first portion of said deck being supported by a rear offset axle, said rear offset axle being coupled with a substantially central axle of at least one wheel supporting said deck via an offset element; and
a lever arm coupled with said rear offset axle;
wherein when said lever arm is in a first position, said deck is in a raised position relative to a surface on which said at least one wheel rests; and
wherein when said lever arm is in a second position, said deck is in a lowered position relative to a surface on which said at least one wheel rests.

2. The trailer of claim 1 further comprising:
an offset axle component adapted and configured to transition said deck between a raised and a lowered position.

3. The trailer of claim 2 wherein said offset axle component comprises:
a first offset component having a first orientation relative to said deck; and
a second offset component having a second orientation relative to said deck.

4. The trailer of claim 3 wherein said first offset component and said second offset component are orthogonal.

5. The trailer of claim 4 wherein a first side of said offset axle component is rotatably coupled with said rear offset axle and an opposing side of said offset axle component is rotatably coupled with said at least one wheel.

6. The trailer of claim 5 wherein rotation of said offset axle component enables transition of said deck between said first position and said second position.

7. An offset axle assembly comprising:
a central rod;
an axle attachment component coupled with a first end of said central rod;
an offset axle surrounding said central rod such that said central rod can rotate about a longitudinal axis within said offset axle; and
a wheel axle configured to indirectly couple with said central rod;
wherein said longitudinal axis of said central rod is not colinear with a longitudinal axis of said wheel axle.

8. The offset axle assembly of claim 7 further comprising a first offset component and a second offset component and a second offset component;
wherein said first offset component has a first orientation and said second offset component has a second orientation.

9. The offset axle assembly of claim 8 where said first offset component and said second offset component are orthogonal.

10. The offset axle assembly of claim 9 wherein said axle attachment component is coupled to said first offset component.

11. The offset axle assembly of claim 10 wherein said wheel axle is coupled with said first offset component, askew from said axel attachment component.

12. The offset axle assembly of claim 10 wherein said wheel axle is coupled with said second offset component.

13. The offset axle assembly of claim 10 wherein said wheel axle is coupled with said first offset component, offset from said axel attachment component.

14. The offset axle assembly of claim 7 wherein said offset axle is horizontally offset from said wheel axle and adapted to independently rotate about said wheel axle.
